(19) United States
(12) Patent Application Publication
(10) Pub. No.: US 2014/0199078 A1
(43) Pub. Date: Jul. 17, 2014

(54) VISIBLE LIGHT COMMUNICATION METHOD USING DMX-512 NETWORK AND DEVICE FOR THE SAME

(71) Applicant: Electronics and Telecommunications Research Institute, Daejeon (KR)

(72) Inventors: Sang-Kyu LIM, Daejeon (KR); In-Su KIM, Daejeon (KR); Tae-Gyu KANG, Daejeon (KR); Il-Soon JANG, Daejeon (KR); Seong-Hee PARK, Daejeon (KR); Jung-Sik SUNG, Daejeon (KR); Hyun-Joo KANG, Daejeon (KR); Hyun-Chul KANG, Daejeon (KR); Jin-Doo JEONG, Daejeon (KR); Myung-Soon KIM, Daejeon (KR); You-Jin KIM, Daejeon (KR); Dae-Ho KIM, Daejeon (KR); Hyun-Seok KIM, Daejeon (KR); Hyun-Jong KIM, Cheongju-si Chungcheongbuk-do (KR); Jong-Woo CHOI, Daejeon (KR)

(73) Assignee: Electronics and Telecommunications Research Institute, Daejeon (KR)

(21) Appl. No.: 14/060,796

(22) Filed: Oct. 23, 2013

(30) Foreign Application Priority Data
Jan. 17, 2013 (KR) 10-2013-0005533

(51) Int. Cl. H04J 14/08

(52) U.S. Cl. CPC H04J 14/08
USPC 398/103

(57) ABSTRACT

Disclosed herein is a visible light communication method and device using a DMX-512 network. In the visible light communication method, dimming data packets are received. Visible Light Communication (VLC) data packets are generated. The dimming data packets and the VLC data packets are scheduled so that one or more of the VLC data packets are transmitted to Light Emitting Diode (LED) lighting devices connected over a Digital Multiplex (DMX)-512 network between transmission times of the dimming data packets.

### CROSS REFERENCE TO RELATED APPLICATION

This application claims the benefit of Korean Patent Application No. 10-2013-0005533, filed on Jan. 17, 2013, which is hereby incorporated by reference in its entirety into this application.

### BACKGROUND OF THE INVENTION

1. Technical Field

The present invention relates generally to visible light communication technology and, more particularly, to technology for transmitting visible light communication data to be transmitted via visible light communication based on a light source, such as a Light Emitting Diode (LED), up to the light source over a DMX-512 network without changing existing network components.

2. Description of the Related Art

As the use of lighting devices employing an LED, which is a semiconductor device capable of transmitting information using visible light, as a light source, has increased, a lot more attention has been given to a large number of services for transferring information using lighting devices. Visible Light Communication (VLC) systems using LED lighting require a lighting control network required to transmit VLC data from a data provider to lighting devices.

Currently, Digital Multiplex (DMX)-512 used as lighting control network technology is used for the purpose of transferring lighting data (dimming data). Basically, DMX-512 technology can transmit dimming data of 1 byte per channel using 512 channels. When visible light communication data is allocated to DMX-512 channels using the characteristics of DMX-512, DMX-512 can also be used to transfer communication data to be used for visible light communication, as well as transfer dimming data.

In the past, 1-byte communication data was allocated to each DMX-512 channel without change, so that communication data of a maximum of 512 bytes defined in a DMX-512 standard was transferred. However, in visible light communication, there are many cases where the transmission of data of 512 bytes or more is required depending on use environments and purposes, and thus there is a problem in that various requirements requested by visible light communication cannot be satisfied using conventional technology having a limitation of 512 bytes.

Furthermore, in the past, in order to transmit visible light communication data received over the Internet based on a DMX-512 network, separately devised Internet accessible DMX-512 lighting control equipment was required. The reason for this is that conventional DMX-512 lighting control equipment devised only for lighting control cannot receive data for visible light communication over the Internet and does not have the function of processing received data and transferring the processed data to lighting equipment. Consequently, in the case of the conventional technology, in order to transmit visible light communication data received over the Internet based on a DMX-512 network, there is a burden in that every piece of conventional DMX-512 lighting control equipment and related solutions must be replaced.

Therefore, new technology that is capable of transmitting visible light communication data while utilizing conventional DMX-512 lighting control equipment devised only for lighting control is urgently required.

Prior art related to this includes Korean Unexamined Patent Publication No. 2011-0061069 that discloses an LED lighting device that controls DMX-512 data so that the DMX-512 data can be transmitted in conformity with DMX-512 protocol.

### SUMMARY OF THE INVENTION

Accordingly, the present invention has been made keeping in mind the above problems occurring in the prior art, and an object of the present invention is to effectively transfer VLC data, which will be transmitted via visible light communication, up to a light source over a DMX-512 lighting control network.

Another object of the present invention is to effectively transfer VLC data, which will be transmitted via visible light communication, up to a light source over a DMX-512 lighting control network without changing a conventional DMX-512 network or lighting control device.

A further object of the present invention is to transmit VLC data to LED lighting devices connected over a DMX-512 lighting control network even if VLC data to be transmitted via visible light communication exceeds 512 bytes.

Yet another object of the present invention is to suitably fragment VLC data so as to transmit the VLC data over a DMX-512 lighting control network and insert suitable fragmentation information into each data fragment, thus allowing a reception side to precisely and effectively restore data fragments.

In accordance with an aspect of the present invention to accomplish the above objects, there is provided a visible light communication method including receiving dimming data packets; generating Visible Light Communication (VLC) data packets; and scheduling the dimming data packets and the VLC data packets so that one or more of the VLC data packets are transmitted to Light Emitting Diode (LED) lighting devices connected over a Digital Multiplex (DMX)-512 network between transmission times of the dimming data packets.

Preferably, scheduling the VLC data packets may be configured to compare a count value of a Lighting data Transmission Counter (LTC) with a preset Interleaving Ratio (IR), and transmit the VLC data packets and reset the LTC only when a preset comparison condition is satisfied.

Preferably, the preset comparison condition may be a condition in which the count value of the LTC is greater than the preset IR.

Preferably, scheduling the VLC data packets may be configured to, if the count value of the LTC is not greater than the preset IR, transmit the dimming data packets and increase the count value of the LTC.

Preferably, each of the VLC data packets may include a DMX header, fragmentation information, and a data fragment.

Preferably, the data fragments may be generated by dividing (fragmentizing) a VLC frame to be transmitted, and the fragmentation information is information used by a receiver to generate the VLC frame by recombining data fragments corresponding to the VLC data packets.

Preferably, the fragmentation information may include remainder information indicating a number of data fragments remaining after a current data fragment among the data fragments corresponding to the VLC frame.

Preferably, the fragmentation information may include a start flag set only for a first data fragment of the data fragments.

In accordance with another aspect of the present invention to accomplish the above objects, there is provided a device for transmitting Visible Light Communication (VLC) data, including a Digital Multiplex (DMX) signal reception unit for receiving dimming data packets; a VLC data generation unit for generating VLC data packets; and a scheduling unit for scheduling the dimming data packets and the VLC data packets so that one or more of the VLC data packets are transmitted to Light Emitting Diode (LED) lighting devices connected over a Digital Multiplex (DMX)-512 network between transmission times of the dimming data packets.

Preferably, the scheduling unit may be configured to compare a count value of a Lighting data Transmission Counter (LTC) with a preset Interleaving Ratio (IR), and transmit the VLC data packets and reset the LTC only when a preset comparison condition is satisfied.

Preferably, the preset comparison condition may be a condition in which the count value of the LTC is greater than the preset IR.

Preferably, the scheduling unit may be configured to, if the count value of the LTC is not greater than the preset IR, transmit the dimming data packets and increase the count value of the LTC.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a system to which a visible light communication method using a DMX-512 network according to an embodiment of the present invention is applied;

FIG. 2 is a diagram showing a procedure for generating VLC data packets from a VLC frame (communication data);

FIG. 3 is an operation flowchart showing a visible light communication method according to an embodiment of the present invention;

FIG. 4 is a block diagram showing a VLC data transmission device according to an embodiment of the present invention;

FIG. 5 is a block diagram showing a visible light communication lighting device according to an embodiment of the present invention; and

FIG. 6 is an operation flowchart showing a scheduling step performed by a scheduling unit.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

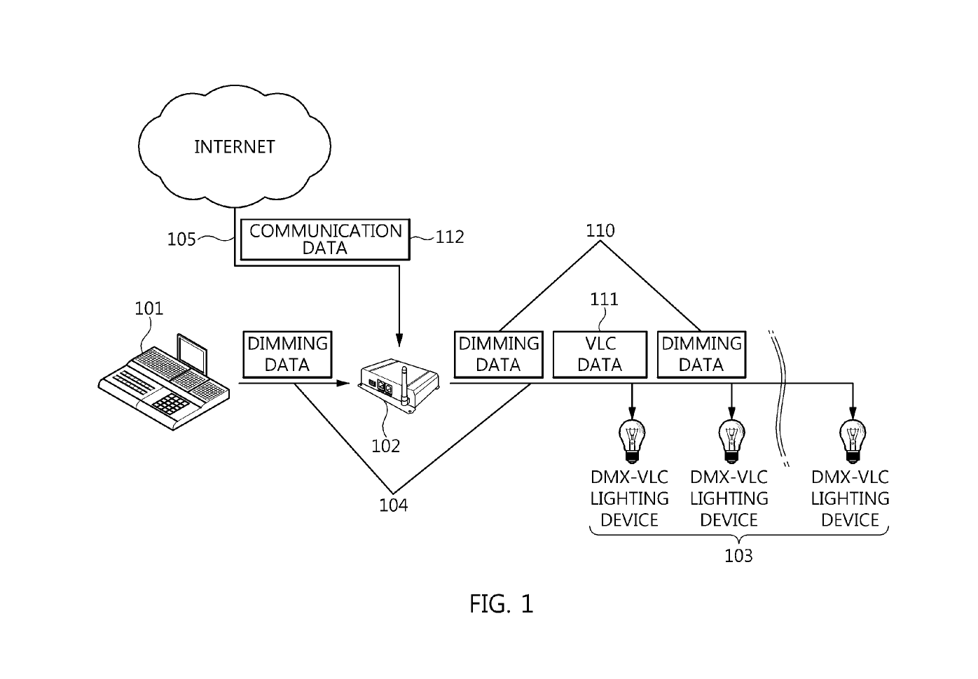

FIG. 1 is a diagram showing a system to which a visible light communication method using a DMX-512 network according to an embodiment of the present invention is applied.

Referring to FIG. 1, the visible light communication system using the DMX-512 network includes a lighting control device 101, a VLC data transmission device 102, and one or more DMX-VLC lighting devices 103.

The lighting control device 101 generates lighting data (dimming data) packets 110 required to control the basic function of lighting, and transmits the dimming data packets to the DMX-VLC lighting devices 103 through a DMX-512 line 104.

The VLC data transmission device 102 is disposed between the lighting control device 101 and the DMX-VLC lighting devices 103. The VLC data transmission device 102 relays the dimming data packets received from the lighting control device 101 to the DMX-VLC lighting devices 103 at the same time that it receives communication data (visible light communication frame: 112) from the Internet via a communication line 105, converts the communication data in the format of VLC data packets 111 which can pass through the DMX-512 network, and transmits the VLC data packets to the DMX-VLC lighting devices.

In this case, the VLC data transmission device 102 sends packet-format dimming data mixed with the VLC data through a single DMX-512 line. The VLC data transmission device 102 lengthens the transmission interval of the dimming data within an allowable limit conforming to a DMX-512 standard and transmits the VLC data between the transmission times of the dimming data.

The DMX-VLC lighting devices 103 may receive data for lighting control from the lighting control device 101 using DMX-512 communication technology, and may receive data for visible light communication from the VLC data transmission device 102 using a visible light communication function if necessary, and transmit the received data via visible light communication. In this case, the VLC data transmission device 102 and the DMX-VLC lighting devices 103 are connected to each other through the DMX-512 line.

That is, the dimming data 110 used for typical lighting control and the VLC data 111 for visible light communication can be transmitted together through the DMX line.

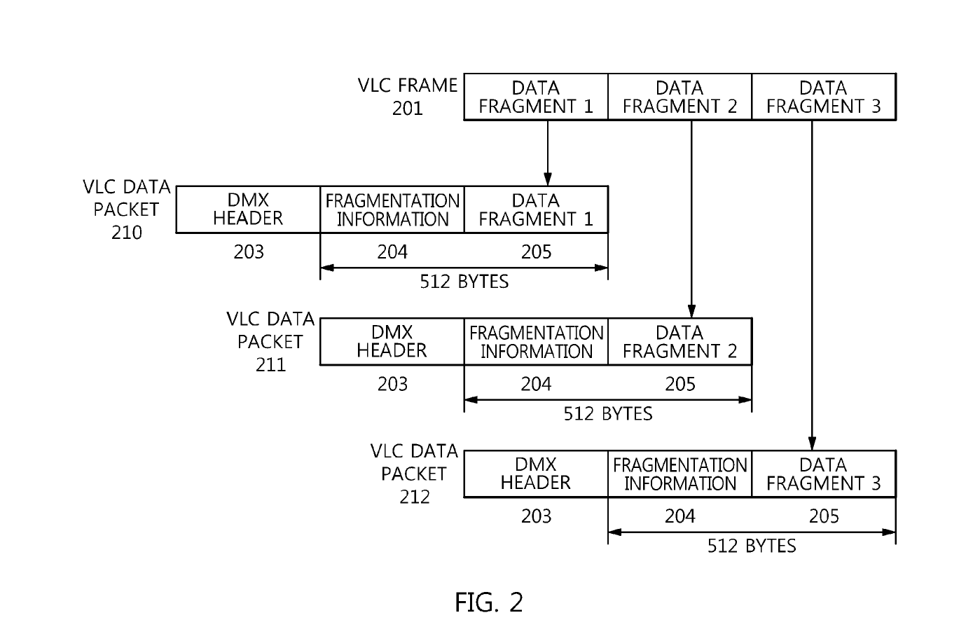

FIG. 2 is a diagram showing a procedure for generating VLC data packets from a Visible Light Communication (VLC) frame (communication data).

Referring to FIG. 2, it can be seen that communication data (VLC frame) 201 of 512 bytes or more cannot be transmitted at a time over a DMX-512 network due to a limited DMX-512 standard, and it is transmitted after being divided into a plurality of data fragments. That is, according to the present invention, the VLC frame 201 is divided into fragments of 512 bytes or less (fragmentation), and respective fragments are separately packetized and transmitted.

VLC data packets 210, 211, and 212 shown in FIG. 2 are DMX-512 packets passing through the DMX-512 network.

A DMX header 203 composed of a Break & MAB (Mark After Break) and a Start Code (SC) is disposed in common at the beginning of each DMX-512 packet.

Fragmentation information 204 disposed subsequent to the DMX header 203 indicates the number of data fragments which remain after a current data fragment 205 so as to complete the VLC frame 201 (communication data). For example, in the fragmentation information of the VLC data 210, remainder information may be set to 2 so as to mean that two data fragments remain after the current data fragment. In the fragmentation information of the VLC data 211, remainder information may be set to 1 so as to mean that one data fragment remains after the current data fragment. In the fragmentation information of the VLC data 212, remainder information may be set to 0 so as to mean that no data fragment remains after the current data fragment.

In this way, when the fragmentation information is inserted into each DMX-512 packet, the DMX-VLC lighting device that received the corresponding packet may recognize how many data fragments must be further received after the current data fragment so as to restore an original VLC frame 201 (communication data) and process the data fragments. If the size of the VLC frame itself does not exceed 512 bytes, data fragments may be transmitted at a time with the remainder information set to 0 in the fragmentation information.

In this case, the remainder information can be set to the number obtained by subtracting 1 from the total number of data fragments corresponding to a single VLC frame, for a first data fragment among data fragments, and can be set such that, for the remaining data fragments, the number of data fragments is sequentially decreased to 0.

Further, fragmentation information may include a start flag set only for a first data fragment among data fragments corresponding to a single VLC frame. Furthermore, the fragmentation information may also include number information corresponding to the serial number of data fragments.

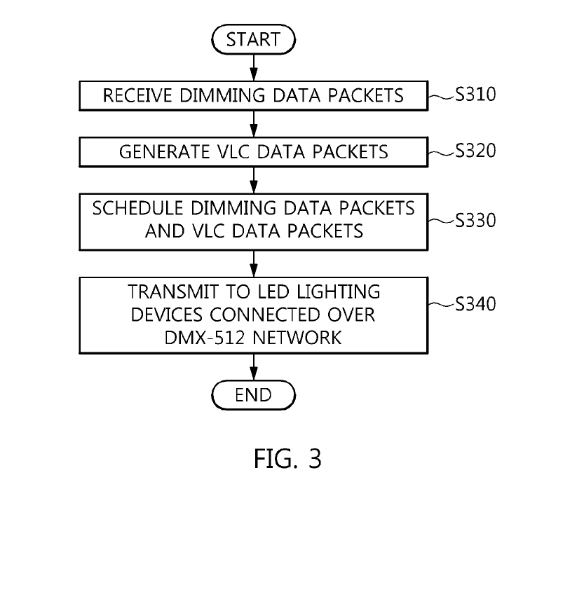

FIG. 3 is an operation flowchart showing a visible light communication method according to an embodiment of the present invention.

Referring to FIG. 3, in the visible light communication method according to the embodiment of the present invention, dimming data packets are received at step S310.

Next, in the visible light communication method according to the embodiment of the present invention, VLC data packets are generated at step S320.

In this case, each VLC data packet may include a DMX header, fragmentation information, and a data fragment.

Here, the data fragments may be generated by dividing (fragmentizing) a VLC frame to be transmitted, and the fragmentation information may be information used to allow a receiver to recombine data fragments corresponding to the VLC data packets and generate the VLC frame.

The fragmentation information may include remainder information indicating the number of data fragments which remain after a current data fragment among data fragments corresponding to the VLC frame.

In this case, the fragmentation information may include a start flag set only for a first data fragment among the data fragments.

Further, in the visible light communication method according to the embodiment of the present invention, the dimming data packets and the VLC data packets are scheduled so that one or more of VLC data packets are transmitted to LED lighting devices connected over the DMX-512 network between the transmission times of the dimming data packets at step S330.

In this case, step S330 may be configured to compare a count value of a Lighting data Transmission Counter (LTC) with a preset Interleaving Ratio (IR) and transmit the VLC data packets and reset the LTC only when a preset comparison condition is satisfied.

Here, the preset comparison condition may be a condition in which the count value of the LTC is greater than the preset IR.

In this case, step S330 may be configured to transmit the dimming data packets and increase the count value of the LTC if the count value of the LTC is not greater than the preset IR.

Next, in the visible light communication method according to the embodiment of the present invention, the dimming data packets and the VLC data packets are transmitted to the LED lighting devices connected over the DMX-512 network, based on the scheduled results at step S340.

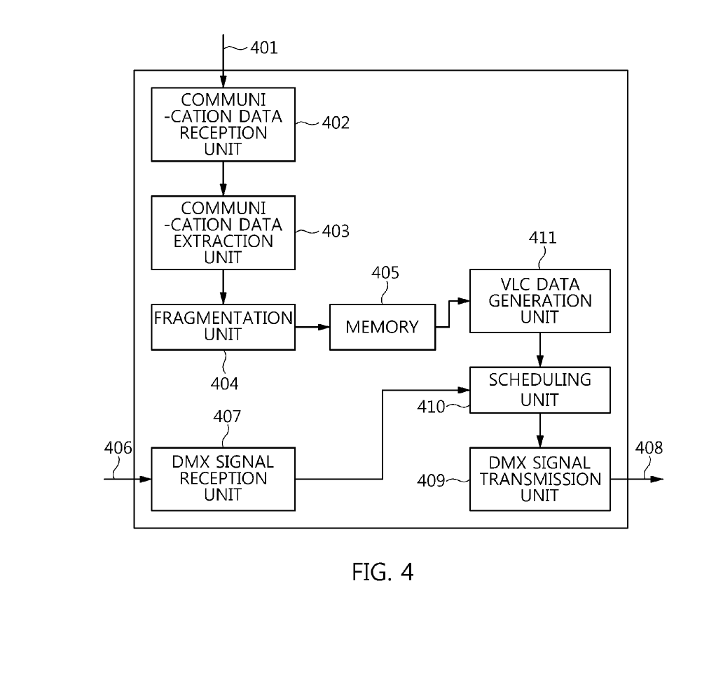

FIG. 4 is a block diagram showing a VLC data transmission device according to an embodiment of the present invention.

Referring to FIG. 4, the VLC data transmission device according to the embodiment of the present invention includes a communication data reception unit 402, a communication data extraction unit 403, a fragmentation unit 404, memory 405, a VLC data generation unit 411, a DMX signal reception unit 407, a scheduling unit 410, and a DMX signal transmission unit 409.

The DMX signal reception unit 407 receives packet-format dimming data from a lighting control device through a DMX input line 406. The DMX signal reception unit 407 transfers the dimming data packet to the scheduling unit 410.

Meanwhile, the communication data reception unit 402 receives communication data through a communication line 401. The communication data reception unit 402 transfers the received communication data to the communication data extraction unit 403. In this case, the communication data may correspond to a VLC frame.

The communication data extraction unit 403 may extract only a data field other than a protocol header and a trailer from the received communication data and transfer the extracted data field to the fragmentation unit 404.

The fragmentation unit 404 divides the extracted data field of the communication data into fragments having a size sufficient to pass through the DMX line, and sequentially stores the fragments in the memory 405. For example, the fragmentation unit 404 may divide the communication data into fragments having a size of 512 bytes or less.

The VLC data generation unit 411 sequentially reads the fragments stored in the memory 405, generates VLC data packets by attaching a header capable of passing through the DMX line to each of the fragments, and transfers the generated VLC data packets to the scheduling unit 410.

Here, the VLC data generation unit 411 sets the start code of each DMX header to a value other than 0 when the generated DMX-512 packets are packets for visible light communication.

The dimming data packets received by the DMX signal reception unit 407 may be generated by the lighting control device shown in FIG. 1. For example, the lighting control device may store dimming data, generated by receiving the input of a lighting operator from a user interface or generated by an automatic control information generation unit, in memory. Further, a DMX signal generation unit provided in the lighting control device may generate DMX-512 packets from the data stored in the memory. In this case, the lighting control device may recognize that the data stored in the memory is dimming data and may insert 0 into the Start Code (SC) of a DMX header. The lighting control device transmits the generated DMX packets to the DMX signal reception unit 407 through the DMX-512 line 406.

The scheduling unit 410 schedules the VLC data packets provided by the VLC data generation unit 411 and the dimming data packets provided by the DMX signal reception unit 407. In this case, the scheduling unit 410 may perform scheduling so that the transmission interval of the dimming data is lengthened within an allowable limit conforming to the DMX-512 standard and the VLC data can be transmitted between the transmission times of the dimming data.

The DMX signal transmission unit 409 transmits the scheduled DMX-512 packets to the DMX-VLC lighting devices through a DMX-512 line 408.

In accordance with an embodiment, the VLC data generation unit 411 may directly transmit the DMX-512 packets to the DMX signal transmission unit 409 without them passing through the scheduling unit 410. In this case, the scheduling unit 410 may suitably schedule timing at which the DMX-512 packets are generated by the VLC data generation unit 411 using VLC data.

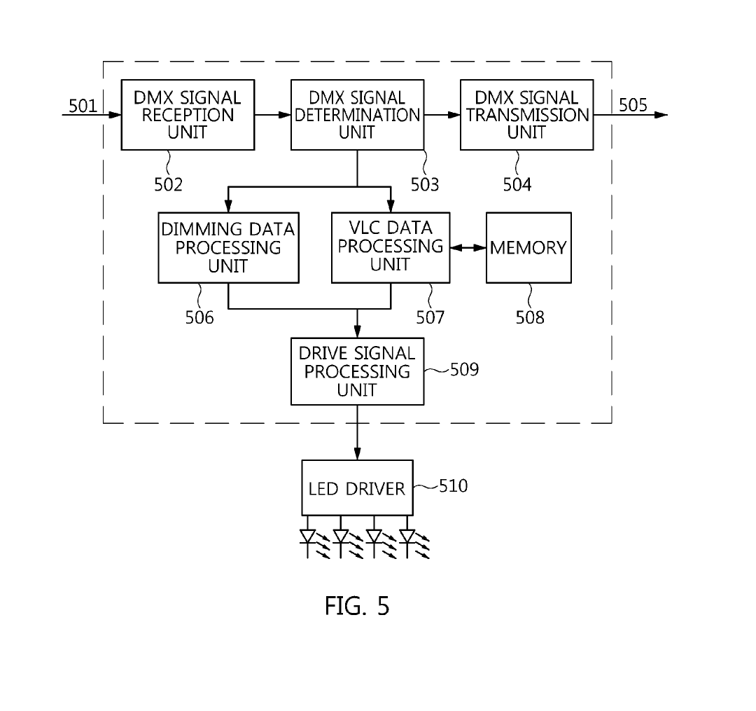

FIG. 5 is a block diagram showing a visible light communication lighting device according to an embodiment of the present invention.

Referring to FIG. 5, the visible light communication lighting device according to the embodiment of the present invention includes a DMX signal reception unit 502, a DMX signal determination unit 503, a DMX signal transmission unit 504, a dimming data processing unit 506, a VLC data processing unit 507, memory 508, a drive signal processing unit 509, and an LED driver 510.

In particular, the visible light communication lighting device shown in FIG. 5 may correspond to the DMX-VLC lighting device shown in FIG. 1.

The DMX signal reception unit 502 transmits a DMX-512 packet input through a DMX line 501 to the DMX signal determination unit 503. The DMX signal determination unit 503 transmits the received DMX-512 packet to a DMX line 505 via the DMX signal transmission unit 504, so as to control other DMX-VLC lighting devices present on a network.

The DMX signal determination unit 503 is configured to, if the start code of the received DMX-512 packet is 0, transmit control information to the DMX dimming data processing unit 506, and enable lighting to be turned on via the drive signal processing unit 509 and the LED driver 510.

If the start code of the DMX-512 packet is a value set for visible light communication other than 0, the DMX signal determination unit 503 sends the data of the received DMX-512 packet to the VLC data processing unit 507, thus enabling visible light communication to be performed. The VLC data processing unit 507 accumulates data in the memory 508 until data of a DMX-512 packet having fragmentation information of 0 is received. If a DMX-512 packet having fragmentation information of 0 is received, the VLC data processing unit 507 loads the data from the memory, generates a completed VLC frame, and transmits the generated VLC frame via visible light communication through the drive signal processing unit 509 and the LED driver 510.

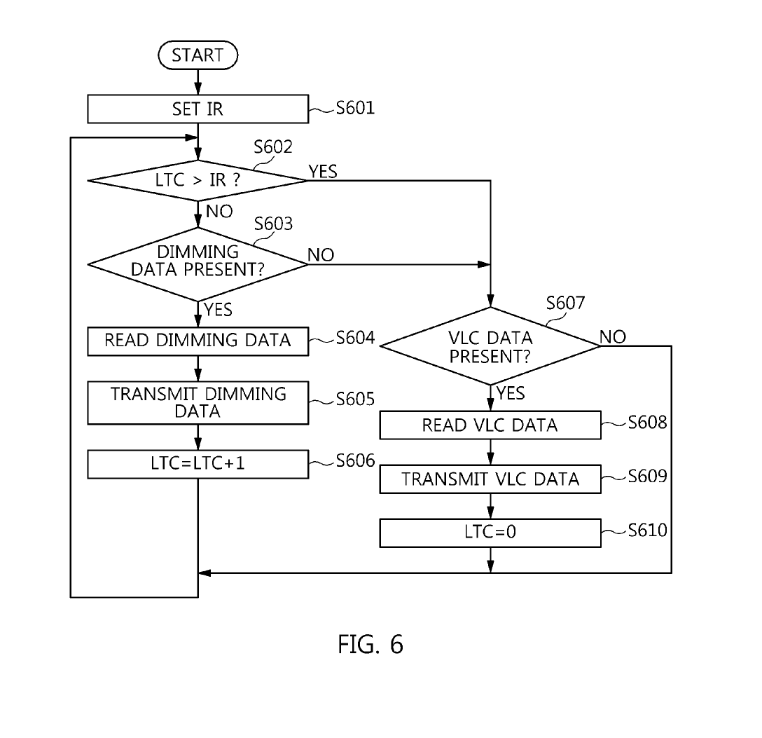

FIG. 6 is an operation flowchart showing a scheduling step performed by the scheduling unit.

Referring to FIG. 6, the scheduling unit sets the Interleaving Ratio (IR) of VLC data packets at step S601.

In this case, the IR may be a preset value determined depending on the characteristics of a lighting network. Generally, in the lighting network, a lighting control function take precedence over a data transmission function, and thus there is a need to guarantee the minimum number of times the dimming data packets are transmitted.

For example, IR may correspond to the number of dimming data packets transmitted during the transmission interval of VLC data packets.

Further, the scheduling unit compares the count value of the Lighting data Transmission Counter (LTC) with the IR, and determines whether the count value of the LTC is greater than the IR at step S602.

In this case, the LTC may store a value obtained by counting the number of dimming data packets transmitted after the transmission of the VLC data packets has occurred.

If it is determined at step S602 that the count value of the LTC is not greater than IR, the scheduling unit determines whether any dimming data packet to be transmitted is present at step S603.

If it is determined at step S603 that any dimming data packet to be transmitted is present, the scheduling unit reads the corresponding dimming data packet at step S604, transmits the dimming data packet to the lighting devices at step S605, increases the count value of the LTC by 1 at step S606, and returns to step S602.

If it is determined at step S602 that the count value of the LTC is greater than IR, or if it is determined at step S603 that no dimming data packet to be transmitted is present, the scheduling unit determines whether any VLC data packet to be transmitted is present at step S607.

If it is determined at step S607 that any VLC data packet to be transmitted is present, the scheduling unit reads the VLC data packet to be transmitted at step S608, transmits the VLC data packet to the lighting devices at step S609, resets the value of the LTC to 0 at step S610, and then returns to step S602.

If it is determined at step S607 that any VLC data packet to be transmitted is not present, the scheduling unit returns to step S602.

In accordance with the present invention, the present invention can effectively transfer VLC data, which will be transmitted via visible light communication, up to a light source over a DMX-512 lighting control network.

Further, the present invention can effectively transfer VLC data, which will be transmitted via visible light communication, up to a light source over a DMX-512 lighting control network without changing a conventional DMX-512 network or lighting control device.

Furthermore, the present invention can transmit VLC data to LED lighting devices connected over a DMX-512 lighting control network even if VLC data to be transmitted via visible light communication exceeds 512 bytes.

Furthermore, the present invention can suitably fragment VLC data so as to transmit the VLC data over a DMX-512 lighting control network and insert suitable fragmentation information into each data fragment, thus allowing a reception side to precisely and effectively restore data fragments.

As described above, in the visible light communication method and device using a DMX-512 network according to the present invention, the configurations and schemes in the above-described embodiments are not limitedly applied, and some or all of the above embodiments can be selectively combined and configured so that various modifications are possible.

What is claimed is:

1. A visible light communication method comprising:
receiving dimming data packets;
generating Visible Light Communication (VLC) data packets; and
scheduling the dimming data packets and the VLC data packets so that one or more of the VLC data packets are transmitted to Light Emitting Diode (LED) lighting devices connected over a Digital Multiplex (DMX)-512 network between transmission times of the dimming data packets.

2. The visible light communication method of claim 1, wherein scheduling the VLC data packets is configured to compare a count value of a Lighting data Transmission Counter (LTC) with a preset Interleaving Ratio (IR), and transmit the VLC data packets and reset the LTC only when a preset comparison condition is satisfied.

3. The visible light communication method of claim 2, wherein the preset comparison condition is a condition in which the count value of the LTC is greater than the preset IR.

4. The visible light communication method of claim 3, wherein scheduling the VLC data packets is configured to, if the count value of the LTC is not greater than the preset IR, transmit the dimming data packets and increase the count value of the LTC.

5. The visible light communication method of claim 2, wherein each of the VLC data packets includes a DMX header, fragmentation information, and a data fragment.

6. The visible light communication method of claim 5, wherein the data fragments are generated by fragmentizing a VLC frame to be transmitted, and the fragmentation information is information used by a receiver to generate the VLC frame by recombining data fragments corresponding to the VLC data packets.

7. The visible light communication method of claim 6, wherein the fragmentation information includes remainder information indicating a number of data fragments remaining after a current data fragment among the data fragments corresponding to the VLC frame.

8. The visible light communication method of claim 7, wherein the fragmentation information includes a start flag set only for a first data fragment of the data fragments.

9. A device for transmitting Visible Light Communication (VLC) data, comprising:
a Digital Multiplex (DMX) signal reception unit for receiving dimming data packets;
a VLC data generation unit for generating VLC data packets; and
a scheduling unit for scheduling the dimming data packets and the VLC data packets so that one or more of the VLC data packets are transmitted to Light Emitting Diode (LED) lighting devices connected over a Digital Multiplex (DMX)-512 network between transmission times of the dimming data packets.

10. The device of claim 9, wherein the scheduling unit is configured to compare a count value of a Lighting data Transmission Counter (LTC) with a preset Interleaving Ratio (IR), and transmit the VLC data packets and reset the LTC only when a preset comparison condition is satisfied.

11. The device of claim 10, wherein the preset comparison condition is a condition in which the count value of the LTC is greater than the preset IR.

12. The device of claim 11, wherein the scheduling unit is configured to, if the count value of the LTC is not greater than the preset IR, transmit the dimming data packets and increase the count value of the LTC.

13. The device of claim 10, wherein each of the VLC data packets includes a DMX header, fragmentation information, and a data fragment.

14. The device of claim 13, wherein the data fragments are generated by fragmentizing a VLC frame to be transmitted, and the fragmentation information is information used by a receiver to generate the VLC frame by recombining data fragments corresponding to the VLC data packets.

15. The device of claim 14, wherein the fragmentation information includes remainder information indicating a number of data fragments remaining after a current data fragment among the data fragments corresponding to the VLC frame.

16. The device of claim 15, wherein the fragmentation information includes a start flag set only for a first data fragment of the data fragments.
